(19) United States
(12) Patent Application Publication
(10) Pub. No.: US 2011/0004561 A1
(43) Pub. Date: Jan. 6, 2011

(54) Contact Information Aggregation

(75) Inventors: Omar H. Shahine, Menlo Park, CA (US); Ann M. Hudspeth, Redmond, WA (US); Paul A. Elliott, Woodinville, WA (US); Peter Bergler, Duvall, WA (US); Jennifer Shen, Santa Clara, CA (US); Thomas Stovicek, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/496,531

(22) Filed: Jul. 1, 2009

(51) Int. Cl. G06Q 99/00

(52) U.S. Cl. 705/319

(57) ABSTRACT

Techniques are described to aggregate contact information. In an implementation, contact information that is associated with a single user and that is obtained from a plurality of services via a network is aggregated. A least one of the services is configured as a social networking service. A user interface is configured to include at least a portion of the aggregated contact information such that the single user is represented above the portion of the aggregated contact information in the user interface.

### BACKGROUND

The growth in popularity of social networking services is ever increasing. Social networking services allow users to interact with online communities that share interests and/or activities, or that are interested in exploring the interests and activities of other users. In this manner, social networking services attempt to mirror real-world social relationships.

Users of a social networking service may use the service to expose profiles to each other that contain contact information. In this way, users may share information about themselves with each other through use of the profiles. For example, a typical profile may contain a user's name, current status, a description of the client's interests, an image (e.g., a photo of the client), and so on. However, users may join multiple and/or different social networking services, which may make it difficult for users to locate and communicate with each other via the services.

### SUMMARY

Techniques are described to aggregate contact information. In an implementation, contact information that is associated with a single user and that is obtained from a plurality of services via a network is aggregated. A least one of the services is configured as a social networking service. A user interface is configured to include at least a portion of the aggregated contact information such that the single user is represented above the portion of the aggregated contact information in the user interface.

In an implementation, one or more computer-readable storage media include instructions that are executable to configure a user interface to include contact information. The contact information is associated with a plurality of respective contacts of a user such that at least one said contact includes aggregated contact information from a plurality of sources. The configured user interface is exposed for local storage and display on a plurality of client devices associated with the user.

In an implementation, one or more computer-readable storage media include instructions that are executable to expose a user interface for access via a network and display by a browser. The user interface includes contact information aggregated from a plurality of social networking services associated with a user and an address book of a client device associated with the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to aggregate contact information from multiple sources.

FIG. 2 is a flow diagram depicting a procedure in an example implementation in which contact information is aggregated from multiple sources.

FIG. 3 is an illustration of an example structure of an interface that is configured for display of aggregated contact information for a contact by a client device.

FIG. 4 is an illustration depicting an example interface that generally employs the structure shown in FIG. 3.

FIG. 5 is an illustration depicting an example interface that is configured to furnish access to aggregate contact information for a plurality of contacts.

FIG. 6 is an illustration depicting an example interface that is configured to provide functionality to link duplicate contacts entries, such as duplicate contact entries within the contact list of the interface of FIG. 5.

FIG. 7 is an illustration depicting an example interface that is configured for the display of aggregated contact information for a contact.

FIG. 8 is an illustration depicting the interface shown in FIG. 7, wherein discrepancies in the profile data received from different sources may be detected and displayed within the interface.

### DETAILED DESCRIPTION

Overview

Social networking services typically allow users to view profile data exposed by other users of the service. The profile data may include contact information of the user, e.g., how to contact the user such as an email address, as well as other information that describes the user, e.g., an image. However, a user of one social networking service may also use several other unrelated social networking services. In such instances, although the user may have access to contact information of users from each of the respective social networking services individually (e.g., by logging on to each service), the contact information may overlap, e.g., when users are members of more than one social networking service.

Additionally, the user may also enter contact information for other users in an address book, such as an address book associated with an email program, a calendaring application, an instant messaging program, the user's mobile communications device (e.g., wireless phone), and so on. Thus, contact information may also be entered in the address book for users that also utilize a social networking service.

Consequently, a user may have multiple sets of contact information that are spread across a variety of different locations, e.g., stored in friend lists associated with different social networking services, stored in contact lists associated with different email programs, and so on. Moreover, this contact information may overlap and contain discrepancies such as omissions, contradictions, typographical errors, and so forth. For example, contact information exposed to a user from another user (e.g., a “friend”) in a social networking service may omit the friend's home address and telephone number. However, the user may have entered this information in an address book of the user's electronic mail program. Similarly, contact information exposed to the user from a friend though two different social networking services may contain different information, such as two different email addresses for the friend.

Techniques are described to aggregate contact information from multiple sources, which may be included in profile data obtained from social networking services, contacts in an address books, and so on. In an implementation, contact information is received for one or more contacts from two or more sources. For example, profile data that includes contact information may be received from multiple social networking services. Additional contact information may also be retrieved from an address book of the user. The received contact information is then aggregated to generate aggregated contact information for each of the contacts. The aggregated contact information may then be exposed to one or more client devices associated with the client.

In an implementation, the aggregated contact information may then be exposed (e.g., by an address book clearing house) to a plurality of client devices associated with the user in an integrated interface, for example, as part of an integrated contacts list. In this way, the contact information for a contact may be represented consistently across the various client devices of the user.

In the following discussion, an example environment is first described that is operable to perform the techniques to perform contact information aggregation. Exemplary procedures are then described which may be employed in the exemplary environment, as well as in other environments without departing from the spirit and scope thereof.

Example Environment

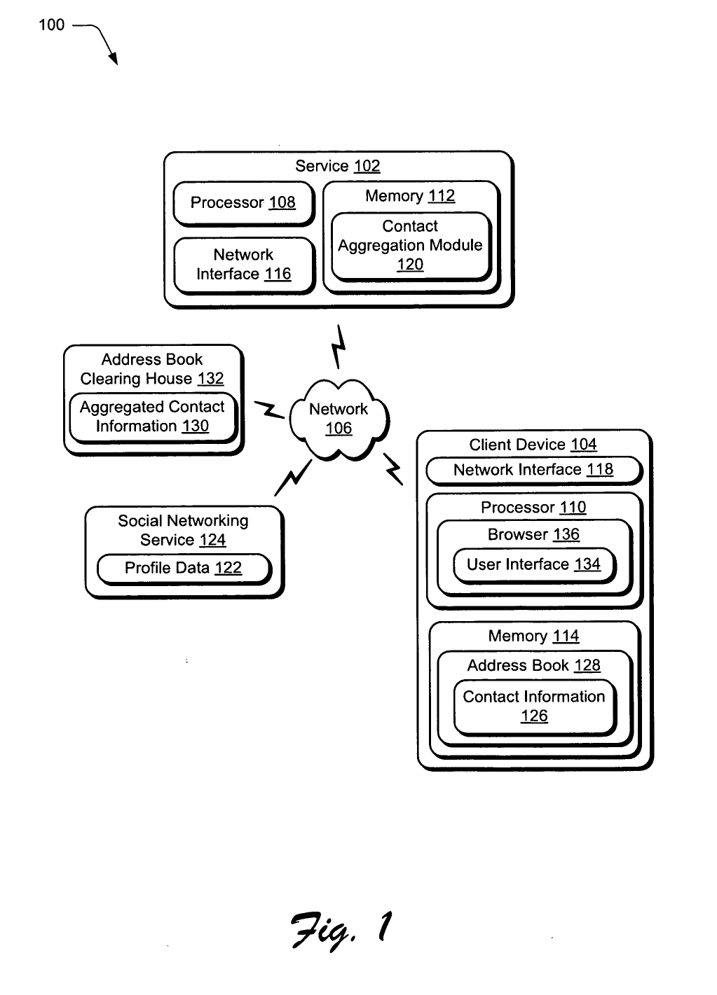

FIG. 1 illustrates an environment 100 in an example implementation that is operable to aggregate contact information from multiple sources, such as social networking services, client address books, and so on. The illustrated environment 100 includes a service 102 that is communicatively coupled to a client device 104 via a network 106.

The service 102 may be configured in a variety of ways and is illustrated as being implemented using one or more computers. In an implementation, the service 102 may be configured as an application service provider (ASP) that is operable to provide services to client device 104. For example, the service 102 may be a social networking service provider using a server configured to provide social networking services to users of the service 102. The service 102 may also be configured to provide a variety of other web services, such as an electronic mail service, an instant messaging service, and so on.

The client device 104 may also be configured in a variety of ways. For example, one or more of the client devices 104 may be configured as a computer such as a desktop or laptop computer that is capable of communicating over a wired or wireless network. The client devices 104 may also be configured as a mobile connected device such as a personal digital assistant, a smart phone, or a cell phone that is capable of communicating over a wireless network; an entertainment appliance; a set-top box communicatively coupled to a display device; a game console, and so forth. Thus, the client devices 104 may range from full resource devices with substantial memory and processor resources (e.g., a personal computer, a game console, etc.) to comparatively low-resource devices with limited memory and/or processing resources (e.g., a cell phone, a set top box, etc.). The client device 104 may be representative of one or more client devices and therefore may be referred to in singular (e.g., client device 104) and/or plural form ((e.g., client devices 104) in the following discussion.

The network 106 may assume a variety of configurations. For example, the network 106 may include the Internet, a wide area network (WAN), a local area network (LAN), a wireless network (e.g., a WIFI (IEEE 802.11) network), a cellular telephone network, a public telephone network, an extranet, an intranet, and so on. Further, although a single network 106 is shown, the network 106 may be configured to include multiple networks. For instance, a desktop or laptop computer may connect to the Internet via a local area network so that the computer's web browser may access a webpage provided by a website within the World Wide Web (WWW). Similarly, a mobile browser in a smart phone may access a webpage within a corporate intranet via a cellular telephone network. A wide variety of other instances are also contemplated.

In FIG. 1, the service 102 is illustrated as being implemented by a server in FIG. 1 and the client device 104 is illustrated as being implemented as a device. Accordingly, each are illustrated as including a respective processor 108, 110; respective memory 112, 114; and a respective network interface 116, 118. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 112, 114 is shown, respectively, for the service 102 and the client device 104, a wide variety of types and combinations of memory may be employed, such as random access memory (RAM), hard disk memory, removable medium memory, and other types of computer-readable storage media.

The network interfaces 116, 118 are representative of functionality to enable the service 102 and client device 104 to communicate with one or more networks, such as network 106. In various implementations, the network interfaces 116, 118 may include a variety of components such as modems, routers, wireless access points, cellular telephone transceivers, and so forth, and are also representative of associated software employed by these components, e.g., drivers, configuration software, and so on. In FIG. 1, the network interfaces 116, 118 are illustrated as being an internal component of the respective devices, i.e., the service 102 and the client device 104. However, it should be readily apparent that these interfaces may be implemented as external modules coupled to the service 102 or client device 104 via a wired or wireless connection.

As illustrated in FIG. 1, the service 102 includes a contact aggregation module 120, which is illustrated as an executable module that is stored in memory 112 and executable by the processor 108. The contact aggregation module 120 is representative of functionality to aggregate contact information from multiple sources. For example, the service 102 may obtain profile data 122 from one or more social networking services 124 that includes contact information. The service 102 may also obtain contact information 126 from an address book 128 of the client device 104. For instance, the address book 128 may be associated with a variety applications and programs that may be executed by the client device 104, such as electronic mail programs, calendaring applications, instant messaging programs, and so on.

The contact aggregation module 120 may aggregate the various contact information obtained the received profile data 122 and contact information 126 from the address book 128 to generate aggregated contact information 130 for a user associated with the contact information. Thus, the aggregated contact information 130 may include a combination of contact information obtained from the social networking service 124 and/or client device 104 to provide a unified experience.

In an implementation, the aggregated contact information 130 may be stored using a suitable storage media that is accessible by multiple client devices 104. For example, the aggregated contact information 130 may be stored in an address book clearing house (ABCH) 132, e.g., as part of an authorization service. For example, the authorization service may be configured to provide access to a plurality of services (e.g., websites) based on a single authentication for a user of an account, e.g., automatically or manually by providing credentials such as a user name and password. The aggregated contact information 130 may then be retrieved from the address book clearing house 132 to be furnished to client devices 104 associated with the user. In this manner, the contact aggregated contact information 130 may be represented consistently across the various client devices 104. For instance, the aggregated contact information 130 may then be published to and stored as part of a friends list of the social networking service 124, an address book maintained locally in memory 114 of the client device 104, and so on.

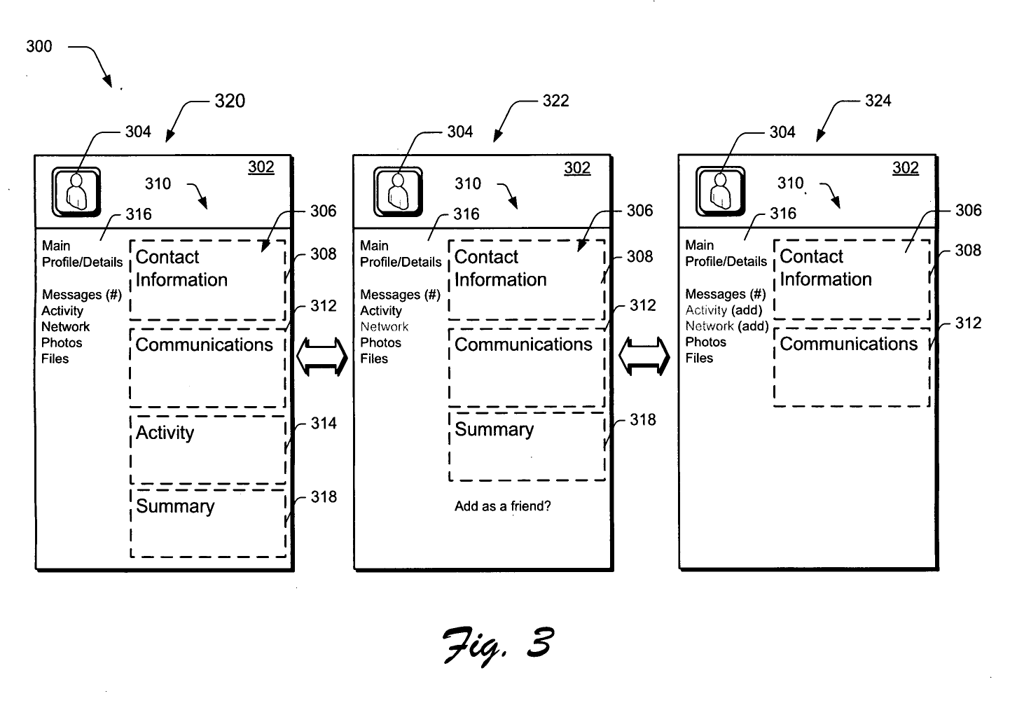

The aggregated contact information 130 may displayed by the various client devices 104 associated with the user using a user interface 134 that is common (e.g., similar) across the devices when displayed. The user interface 134 may be configured to display the aggregated contact information 130 so that profile data 122 and contact information 126 are provided in a common organized view, such as a “stacked” view that does not break the source data (e.g., the profile data 122 and/or the contact information 126 are displayed separately). Example user interfaces 134 that may be used to display the aggregated contact information 130 are illustrated in FIGS. 3-8.

Thus, the user interface 134 may be configured in a variety of ways. As illustrated in FIG. 1, for instance, the user interface 134 is implemented as a webpage element hosted by the service 102 that is communicated to the client device 104 for display by a browser 136. A variety of other examples are also contemplated, such as through execution of a “stand-alone” module by the client device 104, as part of a network-enabled application, and so on.

Generally, any of the functions described herein may be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, a module represents executable instructions that perform specified tasks when executed on a processor, e.g., processors 108, 110. The program code may be stored in one or more computer readable storage media, e.g., memory 112, 114. The features of the aggregation techniques described below are platform-independent, meaning that the techniques may be implemented on a variety of commercial computing platforms having a variety of processors.

Example Procedures and User Interfaces

The following discussion describes procedures that implement techniques to aggregate contact information from multiple sources for presentation in a user interface. Aspects of the procedures may be implemented in hardware, firmware, software, or a combination thereof. The procedures are shown as a set of blocks that specify operations performed by one or more devices and are not necessarily limited to the orders shown for performing the operations by the respective blocks.

This section also presents examples of the user interface 134 that may be generated to expose aggregated content information 130 from multiple sources for use by a user, e.g., through one or more client devices 104 associated with the user. Aspects of the user interface 134 may also be generated by hardware, firmware, software or a combination thereof. In portions of the following discussion of the procedures and user interfaces, reference will also be made to the environment 100 of FIG. 1.

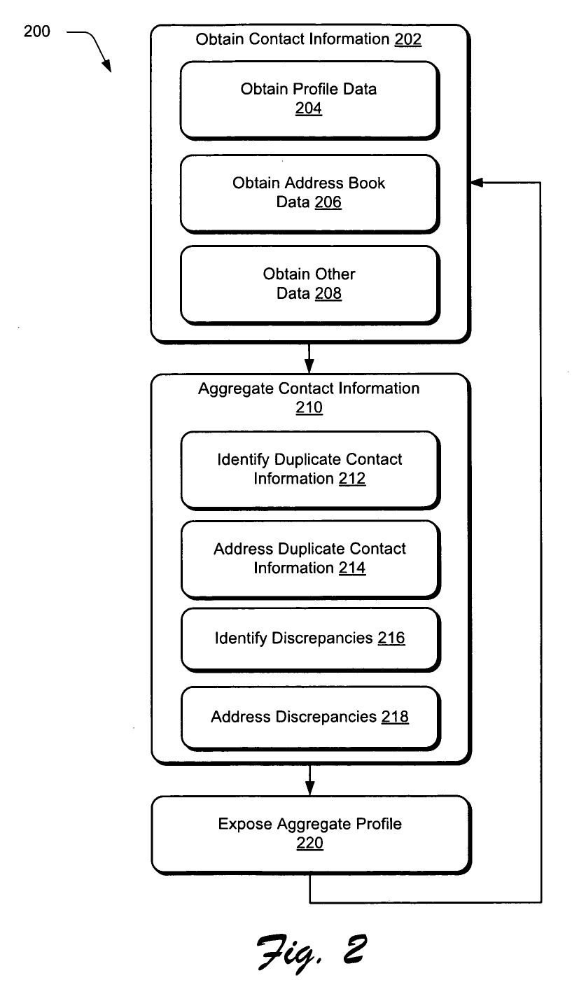

FIG. 2 depicts a procedure 200 in an example implementation in which contact information is aggregated from multiple sources and displayed by a client device in a user interface. As discussed in relation to FIG. 1, contact information may be obtained (block 202) for one or more contacts from multiple sources. For example, profile data (which includes contact information) may be obtained for friends of a user from one or more social networking services (block 204). Similarly, address book data that includes contact information may be obtained from address books of one or more client devices associated with the user (block 206) to generate aggregated contact information. Additionally, other data may be obtained (block 208) from various sources that may or may not be associated with the user. This data may include photographs posted by a user associated with the contact on a photograph sharing website, blog entries associated with the contact posted on a blog site, email messages from the contact, instant messages, and so on. Thus, contact information may be obtained (received or retrieved) from a variety of different sources.

The contact information is then aggregated (block 210). Aggregation of the contact information may be performed using a variety of different functionality. For example, duplicate contact information is identified (block 212) that was received from two or more sources (e.g., two social networking services, a social networking service and an address book, and so on) that are associated with a single user. The duplication of the contact information may be identified as belonging to a single user in a variety of ways. For example, profile data from two different social networking services may be identified as being duplicative because a common screen name is used in each service. In another example, entries in the address books of two different client devices 104 may be identified as duplicative because the entries contain a common address or telephone number even though the name of the entries may differ, e.g., due to typographical error, formatting differences, user of different surname (e.g., Bill vs. William), and so on.

The duplicate contact information may then be addressed (block 214) in a variety of ways. For example, contact information that has been identified as duplicative for a contact may be indicated to the user through the user interface 134 to manually resolve the duplication. Through the user interface 134, for instance, the user may then be presented with an option to allow the duplicate contact information to be linked. In other words, the user in this instance verifies whether the aggregation is to be performed such that duplicate entries may be removed, indicated as duplicative, and so on.

In other implementations, the duplicate contact information may be resolved automatically in accordance with a predetermined set of rules, which may be set by the user or other entity beforehand. For instance, the rules may be set to resolve conflicts regarding the contact information such that an address retrieved from an address book entry that was entered manually by the user may be given precedence over an address retrieved from a profile of a social networking service. A variety of other examples are also contemplated. For example, duplicate contact information received from multiple sources for a contact may be retained and displayed in an ordered manner and cross-referenced to the source from which the information was received.

Discrepancies in the contact information may also be detected (block 216) and addressed (block 218). For example, profile data for a contact received from a first social networking service may include a telephone number that differs from a telephone number entered by the user for the contact in an address book, the address entered by the user in two address books may differ (e.g., due to a typographical error), and so on. The identified discrepancies may then be addressed manually by providing the user with options to resolve the discrepancy, the discrepancy may be resolved automatically, and so on.

The aggregated contact information is then exposed (block 220). For example, the aggregated contact information 130 may be stored in a suitable storage system such as an address book clearing house (ABCH) 132 as described in relation to FIG. 1 for use by client devices 104 that may access the ABCH 132 over the network 106. Thus, the aggregated contact information 130 may be accessed by a variety of different client devices 104 and services 102 to provide consistent aggregated contact information 130, one to another.

The process 200 may be repeated when new or modified contact information is available, which is illustrated by an arrow that connects block 220 with block 202. For example, a client may choose to update contact information within a contact list. This update may then be populated to other devices and services through use of the aggregated contact information 130. This may be performed manually by the user (e.g., by selecting an “update” option in the user interface) and/or automatically without further user intervention (e.g., through execution of the contact aggregation module 120). A variety of different user interfaces 134 may be output to include the aggregated contact information 130, examples of which may be found in relation to the following figures.

FIG. 3 depicts an example interface structure 300 of a user interface 134 configured for the display of an aggregated contact information for a contact. As illustrated, the interface structure 300 includes a heading 302 having identification information for the contact. For example, the heading 302 may include a graphic 304 such as a photograph or drawing associated with the contact and/or textual identification information such as the name or nickname of the contact, the contact's address, the current status of the contact, and so on.

The interface structure 300 may further include an aggregated contact information display area 306 configured to display summary information extracted from the aggregated contact information in an ordered manner. For example, the aggregated contact information display area 306 may be configured in one or more sections to display contact information 308 received from an address book of a client device utilized by the user (e.g., client device 104) and profile data 310 received from network sources such as social networking services 126, email services, instant messaging services, and so on.

The profile data 310 may include a variety of information that may be arranged in the various sections. For example, in the illustrated embodiment the interface structure 300 includes sections that depict a summary of current or recent communications 312 from the contact such as email communications, instant messages, SMS messages, MMS messages, and so on. The illustrated interface structure 300 also describes recent activity 314 by the contact such as a notice that photographs were uploaded to a photograph sharing website, updates to blog entries, status updates to a social network service, and so on. A menu 316 may also be provided to access detailed information about the contact that is not currently displayed in the summary provided for by the interface structure 300. Other structures are possible.

The interface structure 300 may further support a summary 318. In an implementation, the summary 318 includes a display a variety of information such as friends of the contact, interests of the contact, content (e.g., video, audio, etc.) exposed by the contact, and so forth.

The interface structure 300 may also be configured to support “real time” variations in the contact information, including a status of a contact. As illustrated in FIG. 3, for instance, when the contact is a member of a social networking service to which the user also belongs, the interface 300 may include additional profile data 310 that is available from the service 102 that would not be available otherwise.

In FIG. 3, the interface structure 300 is illustrated as assuming a variety of configurations. For example, in a first configuration 320 the interface structure 300 is configured to accommodate instances wherein the contact and user are both connected to the social networking service 124 and the contact is a friend of the user. In such instances, the interface structure 300 may support the display of information such as recent activity by the contact 312 (e.g., determined from the social networking service), summary 318, and so on.

In a second configuration 322, the interface structure 300 is configured to accommodate instances wherein the contact and user are both connected to a common social networking service, but the contact is not yet a friend of the user. Thus, the interface structure 300 is configured to support the summary 318 but does not include recent activity 314 of the contact 312 (as displayed in the first configuration 320) when this information is not available.

In a third configuration 324, the interface structure 300 is configured to accommodate instances in which the contact and the user are not members of a common social networking service. Accordingly, the interface structure 300 is configured to display contact information 308 retrieved from an address book and communication data 312 describing recent communications with the contact, since additional contact data 310 from the social networking service is not available. It should be readily apparent that a variety of other services are also contemplated as previously described in relation to FIG. 1.

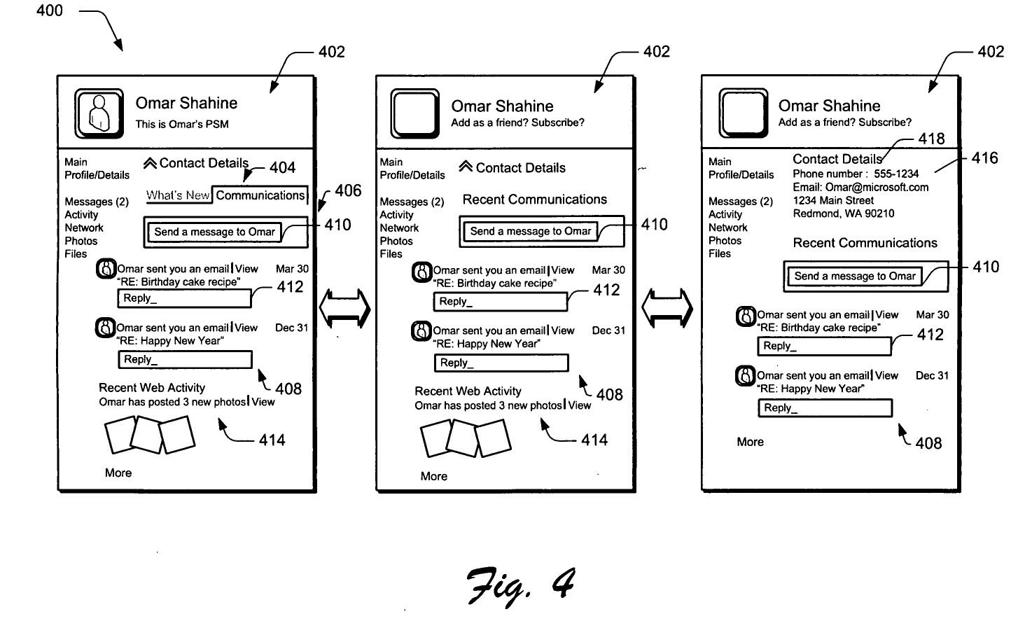

FIG. 4 depicts an example user interface 400 that generally employs the structure 300 shown in FIG. 3. As illustrated, contact information arranged as profile data 402 is configured under a tabbed layout 404 that includes tabs for the various profile data 402 available for the contact. A variety of tabs may be provided, illustrated examples of which include “Communications” and “What's New” tabs in the user interface 400.

When the “Communications” tab is selected, the user interface 400 furnishes access to a variety of communications options 406 for the contact. For example, selection of the “Communications” tab may cause display of a list 408 of communications received from the contact as well as options for communicating with the contact, such as controls to send a new communication 410 to the contact or reply 412 to communications received from the contact. When the “What's New” tab is selected, “new” information is displayed in the user interface 400, such as status information, activity information, and so on in “real time.” Recent network activity 414 (e.g., uploading of photographs to a photograph sharing service by the contact) may also be displayed using this feature.

In the embodiment illustrated, contact information such as the contact's address, telephone number, email address, and so on is displayed in a contact information field 416, which is illustrated as being hidden until selected for viewing. For example, selection of the “Contact Details” heading 418 may cause display of the contact information field, which is then expanded (e.g., through use of an animation) to display available contact information. The contact information field 416 may be hidden again by selecting “Contact Details” heading 418, or may be automatically hidden after a duration of time (e.g., after “timing out”).

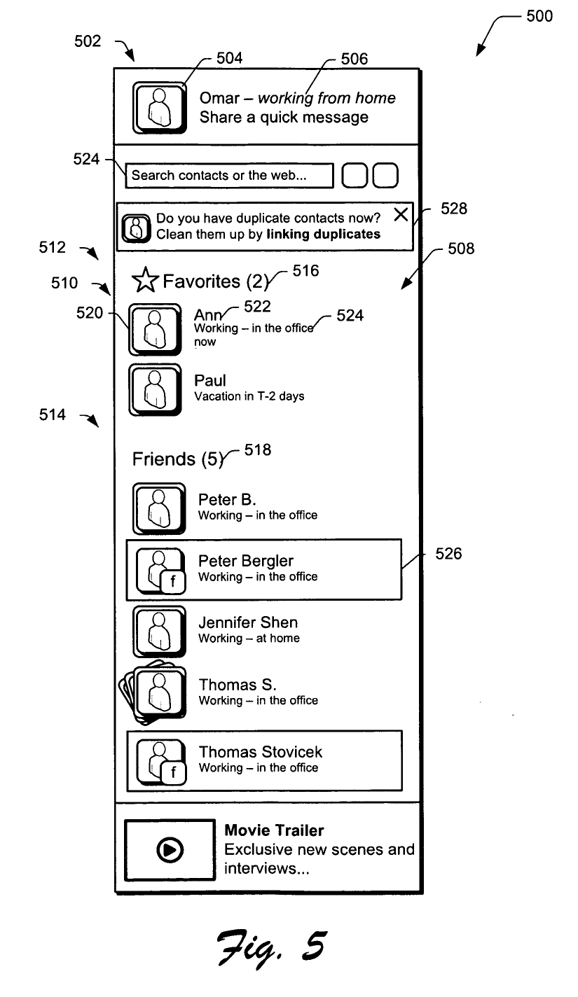

FIG. 5 depicts an example user interface 500 that is configured to furnish access to aggregated contact information for a plurality of contacts. The user interface 500 includes a heading 502 that has identification information for the user. As illustrated, the heading 502 includes a graphic 504 (e.g., a photograph or drawing) associated with the user of the client device 104, textual identification information 506 (e.g., legal name or nickname), a status update that was provided to a social network service (e.g., “working from home”), and so on. The heading 502 also includes a control configured to allow the user to enter a new status message that may be exposed to members of one or more social networking services to which the user belongs, which is illustrated as “Share a quick message.”

The user interface 500 also includes a list 508 having entries (e.g., Ann 510) that are contacts of the user. In an embodiment, the entries in the contacts list 508 may be partitioned into groups. For example, in FIG. 5 the list 508 is depicted as being divided into a “Favorites” group 512 and a “Friends” group 514. Each group includes a respective heading that indicates the number of contacts within the group (e.g. “Favorites (2)” 516 and “Friends (4)” 518) that are accessible to the user through the social networking service or other service.

Contacts may be assigned to the groups in a variety of ways. For example, the user may be prompted to designate an entry associated with a particular contact as belonging to either the “Favorites” group 512 or the “Friends” 514 in response to a friend invitation received from the contact. The number and types of groups available may be predetermined or variable (e.g., set by the client, the service, and so forth).

The entries within the list 508 may be configured to provide a variety of information related to the identity and/or status of the represented contacts. For example, an entry (e.g., Ann 510) may be configured to include a graphic (e.g., a photograph 520 or drawing) that is associated with the contact. The Ann 510 entry in the list 508 also includes textual identification information including the name 522 or nickname of the contact, a current status update 524 that is exposed by the contact, and so on. Other information may be furnished by the list 508.

In an embodiment, the user interface 500 is also provided with search functionality that allows the user to search for contacts within the list 508, search for information via one or more networks such as the World Wide Web, and so on. For example, the user interface 500 may include a search field 524 that provides functionality to receive search criteria to be used to search the list 508, one or more social networking services, websites, and so forth for contacts, contact information, other information, and so forth.

In some implementation, aggregation of contact information may result in duplicate entries in the list 508. For example, entries may describe contact information obtained from two different social networking services as previously described. Accordingly, the user interface 500 may be configured to identify entries that are likely duplicated within the list 508, such as by using a box 526 that encloses the entry. The user interface 500 is further configured to prompt the user to cause the duplicate entries to be linked, thereby eliminating the display of the duplicates. As shown in FIG. 5, for instance, the user interface 500 may include a link control 528 that is selectable to cause the duplicate entries to be linked into a single entry, further discussion of which may be found in relation to the following figure.

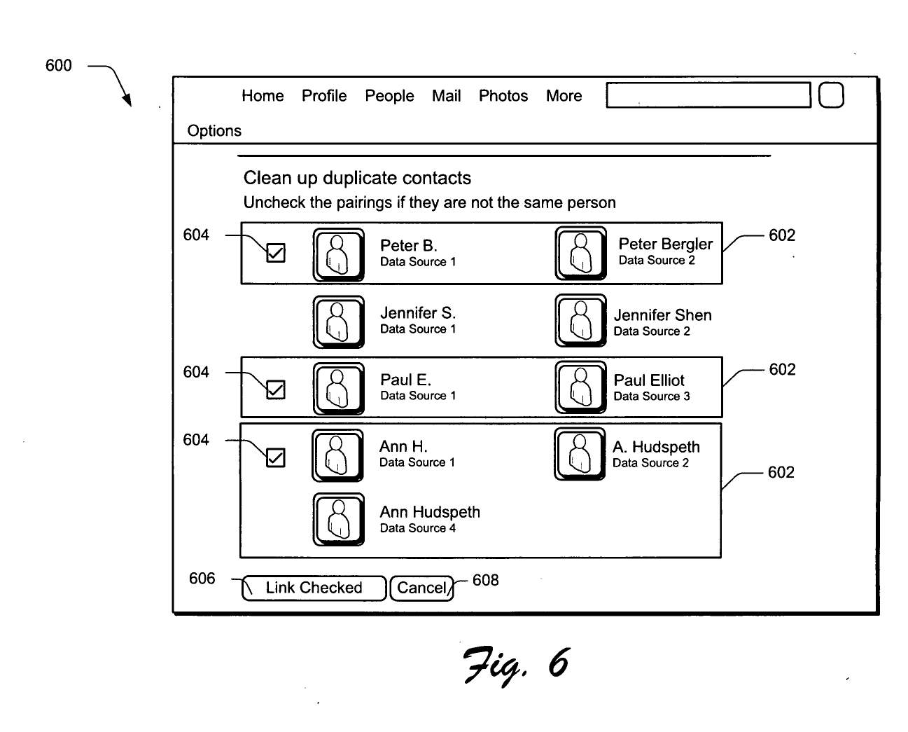

FIG. 6 depicts an example user interface 600 that is output in response to selection of a control in the user interface 500 of FIG. 5 to link duplicate entries. The user interface 600 is configured to display entries 602 having an increased likelihood of being duplicates for possible linking. Therefore, a user may interact with the user interface 600 to select and verify those entries 602 that are to be linked for display as a single entry.

In the illustrated example, duplicate entries that have a likelihood of being duplicates (e.g., same telephone number, same address, and so on) are grouped together within boxes 602. A check box 604 is provided within each respective box 602 to indicate which entries are to be linked. In an implementation, the default state of each check box 604 is “checked”. Therefore, a user may allow the check box 604 to remain “as is” when the entries within the box 602 are duplicates and “uncheck” the check box 604, e.g., via a cursor control device when the entries are not duplicates. Once the user has designated which of the entries are to be linked, the user may then select the “Link Checked” 606 button to cause the entries within the box 602 to be linked for display as a single entry. The link function may be canceled by selecting the “Cancel” 608 button.

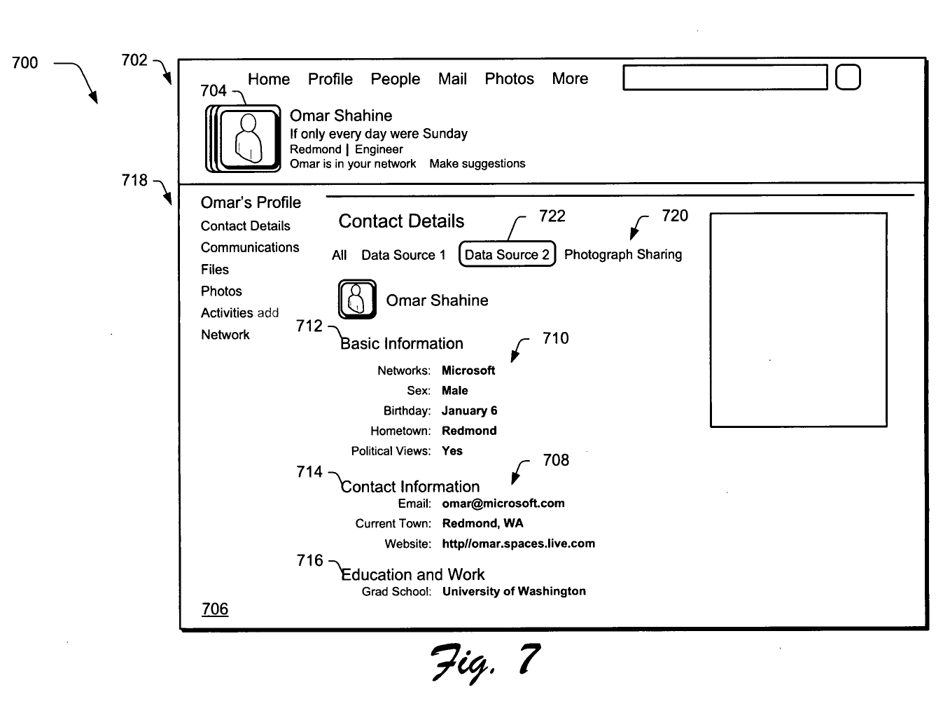

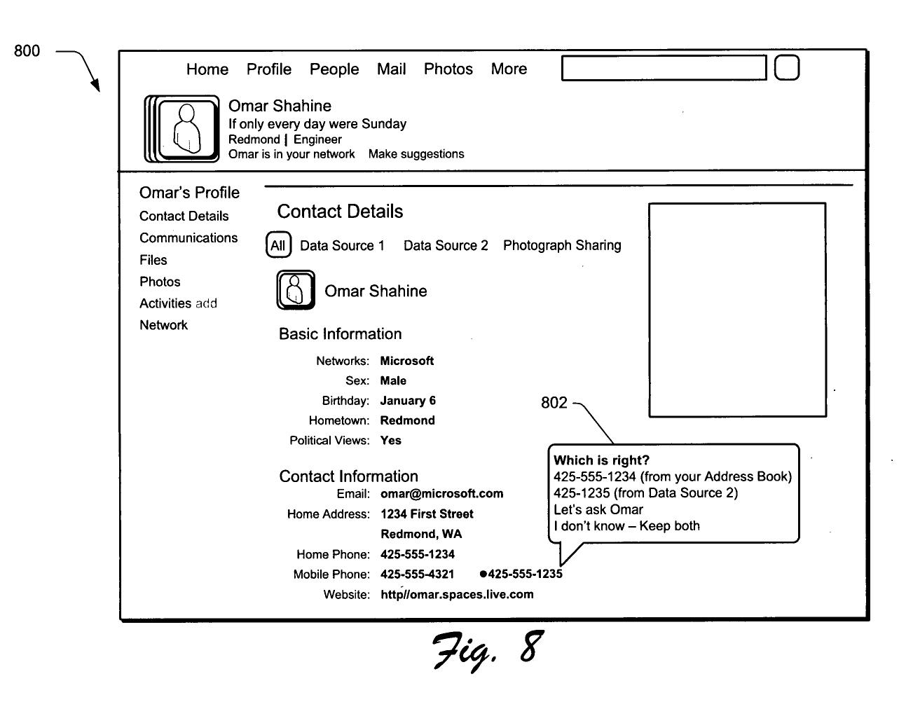

FIGS. 7 and 8 depict examples of user interfaces 700, 800 that are configured to display aggregated contact information for a contact. The user interface 700 of FIG. 7 includes a heading 702 having identification information for the contact as previously described, including a graphic 704, information on whether the contact is a member of the user's social network, and so on.

The user interface 700 further includes an aggregated contact information display area 706 configured to display information taken the aggregated contact information 130 in an ordered manner. For example, the aggregated contact information display area 706 may include one or more sections to display contact information 708 received from an address book of a client device utilized by the client (e.g., client device 104) and profile data 710 received from network sources such as a social networking service 124, an email service, an instant messaging service, and so on.

The profile data 710 includes various sections to further organize the contact information, e.g., with the labels “Basic Information” 712, “Contact Information” 714, “Education and Work” 716, and so on. A menu 718 is also included to provide access to additional information about the contact, communication functionality to communicate with the contact (e.g., to send email, instant messages, SMS texts, MMS messages, and so on), to share files with the contact, to access photographs uploaded into a photograph sharing website by the contact, to view the contacts recent activities, to access network functionality, and so on.

As illustrated, profile data 704 is arranged using a layout 720 that includes portions 722 to cause the display of profile data received from the various sources available for the contact. A variety of portions 722 may be provided. For example, the layout 720 illustrated in FIGS. 7 and 8 may include portions 722 labeled “All” to display a summary of profile data received from the various sources, individual tabs for each source, tabs for displaying photographs from a photograph sharing website, and so on.

As shown in FIG. 8, discrepancies in the profile data received from different sources may be detected and displayed within the user interface 800. For example, profile data for a contact received from a first social networking service may include a data element (e.g., a telephone number in a field) that differs from another data element, such as a telephone number entered by the user for the contact in an address book.

The discrepancy may be noted in the user interface 800 within a bubble 802 to prompt the user to identify the correct data, e.g., “Which is right?” along with a list of the data having the discrepancy. The bubble 802 may further provide options for identifying the correct data (e.g., telephone number) if the user is unable to do so. For instance, as illustrated, the bubble 802 includes a control to initiate communication with the contact to ascertain the correct data, e.g., “Let's ask Dave” or to keep both data elements, e.g., “I don't know—keep both.” For example, a message may be formed automatically and without user intervention upon selection of the control that provides the contact (e.g., Dave) with an option to verify correctness of the information and/or make a change if the information is incorrect. A variety of other examples are also contemplated.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer implemented method comprising:
aggregating contact information that is associated with a single user and that is obtained from a plurality of services via a network, at least one of the services being configured as a social networking service; and
configuring a user interface to include at least a portion of the aggregated contact information such that the single user is represented above the portion of the aggregated contact information in the user interface.

2. The computer-implemented method as described in claim 1, wherein the single user is represented in a header at a top level of the user interface that includes a name of the user and an image selected by the user for use in a profile exposed on the social networking service.

3. The computer-implemented method as described in claim 1, further comprising causing the aggregated contact information to be stored for access via a network to update a plurality of client devices associated with a particular user.

4. The computer-implemented method as described in claim 3, wherein the update is provided automatically and without user intervention in response to a change in the contact information at one or more of the plurality of services or the plurality of client devices.

5. The computer-implemented method as described in claim 1, wherein the plurality of services include a plurality of social networking services.

6. The computer-implemented method as described in claim 1, wherein at least one of the services includes a social networking service and the aggregating further comprises obtaining contact information from an address book of a client device.

7. The computer-implemented method as described in claim 1, wherein the aggregating includes identifying duplicate said contact information and addressing the duplicate said contact information.

8. The computer-implemented method as described in claim 7, wherein the addressing includes outputting an option in the user interface to link the duplicate said contact information.

9. The computer-implemented method as described in claim 7, wherein the addressing includes merging the duplicate said contact information automatically and without user intervention based on one or more predefined rules.

10. The computer-implemented method as described in claim 1, wherein the aggregating includes identifying the contact information that has discrepancies, one to another, and addressing the discrepancies.

11. The computer-implemented method as described in claim 10, wherein the addressing includes outputting an option in the user interface to receive an input to correct the discrepancies.

12. The computer-implemented method as described in claim 10, wherein the addressing includes correcting the discrepancies automatically and without user intervention based on one or more predefined rules.

13. One or more computer-readable storage media comprising instructions that are executable to:
configure a user interface to include contact information that is associated with a plurality of respective contacts of a user such that at least one said contact includes aggregated contact information from a plurality of sources; and
expose the configured user interface for local storage and display on a plurality of client devices associated with the user.

14. The one or more computer-readable storage media as described in claim 13, wherein the aggregated contact information is exposed by an authentication service.

15. The one or more computer-readable storage media as described in claim 13, wherein one or more of the sources include an address book maintained locally on at least one of the client devices.

16. The one or more computer-readable storage media as described in claim 13, wherein one or more of the sources is a social network service.

17. The one or more computer-readable storage media as described in claim 16, wherein the aggregated contact information includes a status update communicated via the social network service.

18. The one or more computer-readable storage media as described in claim 13, wherein the aggregated contact information includes contact information that was obtained from the plurality of sources and processed to remove duplicates and discrepancies.

19. One or more computer-readable storage media comprising instructions that are executable to expose a user interface for access via a network and display by a browser, the user interface including contact information aggregated from a plurality of social networking services associated with a user and an address book of a client device associated with the user.

20. The one or more computer-readable storage media as described in claim 19, wherein the instructions are further configured to authenticate the user to access the contact information at the plurality of social networking services without user intervention.
